(19) United States
(12) Patent Application Publication
(10) Pub. No.: US 2026/0194775 A1
(43) Pub. Date: Jul. 9, 2026

(54) PROJECTION APPARATUS

(71) Applicant: SEIKO EPSON CORPORATION, Tokyo (JP)

(72) Inventors: Kazunari SAKAMOTO, SUWA-SHI (JP); Osamu NAKAJIMA, HARA-MURA (JP)

(21) Appl. No.: 19/443,571

(22) Filed: Jan. 8, 2026

(30) Foreign Application Priority Data
Jan. 9, 2025 (JP) 2025-003229

(51) Int. Cl. G02F 1/1333; G03B 21/00; G03B 21/16

(52) U.S. Cl. CPC G02F 1/133354; G02F 1/133325; G02F 1/133385; G03B 21/006; G03B 21/16

(57) ABSTRACT

A projection apparatus includes: an electro-optical panel including a first substrate, a second substrate, and a third substrate bonded to one of the first substrate and the second substrate; a holding member configured to hold the electro-optical panel; a liquid flowing member disposed to overlap with an end portion of the third substrate and the holding member in a plan view; and a thermally conductive member disposed between the third substrate and the liquid flowing member and between the holding member and the liquid flowing member.

The present application is based on, and claims priority from JP Application Serial Number 2025-003229, filed January 9, 2025, the disclosure of which is hereby incorporated by reference herein in its entirety.

### BACKGROUND

### Technical Field

The present disclosure relates to a projection apparatus.

### Related Art

In recent years, projection apparatuses have been required to be small, high-luminance products. In a projection apparatus using a liquid crystal panel as a light modulator, it has been proposed to use a liquid-cooling-type cooling structure having high cooling efficiency to prevent deterioration of light resistance of the liquid crystal panel.

For example, JP-A-2021-033032 discloses a projector including a light-incident-side member including a liquid flowing tube that circulates a coolant along a rectangular annular frame body that supports a liquid crystal panel. According to JP-A-2021-033032, a light-incident-side dustproof substrate is provided at the light incident surface of the liquid crystal panel, and a second fixing member made of an adhesive is disposed between a circumferential edge portion of the light-incident-side dustproof substrate and the liquid flowing tube of the light-incident-side member.

JP-A-2021-033032 is an example of the related art.

The projector disclosed in JP-A-2021-033032, however, has room for improvement. In detail, when the light-incident-side dustproof substrate integrated with the liquid crystal panel and the liquid flowing tube are fixed to each other with an adhesive, the limited thermal conductivity of the adhesive makes efficient heat dissipation difficult.

That is, there is a demand for a projection apparatus having high cooling efficiency and high image quality.

### SUMMARY

A projection apparatus according to an aspect of the present disclosure includes: an electro-optical panel including a first substrate, a second substrate, and a third substrate bonded to one of the first substrate and the second substrate; a holding member configured to hold the electro-optical panel; a liquid flowing member disposed to overlap with an end portion of the third substrate and the holding member in a plan view; and a thermally conductive member disposed between the third substrate and the liquid flowing member and between the holding member and the liquid flowing member.

### BRIEF DESCRIPTION OF THE DRAWINGS

FIG. 1 is a schematic configuration diagram of a projection apparatus according to a first embodiment.

FIG. 2 is a perspective view of an image generation module.

FIG. 3 is a perspective view of an electro-optical apparatus.

FIG. 4 is an exploded perspective view of the electro-optical apparatus.

FIG. 5 is a perspective cross-sectional view of the electro-optical apparatus taken along the line b-b in FIG. 3.

FIG. 6 is a diagrammatic cross-sectional view of key parts of the electro-optical apparatus taken along the line b-b in FIG. 3.

### DESCRIPTION OF EMBODIMENTS

### First embodiment

Configuration of projection apparatus

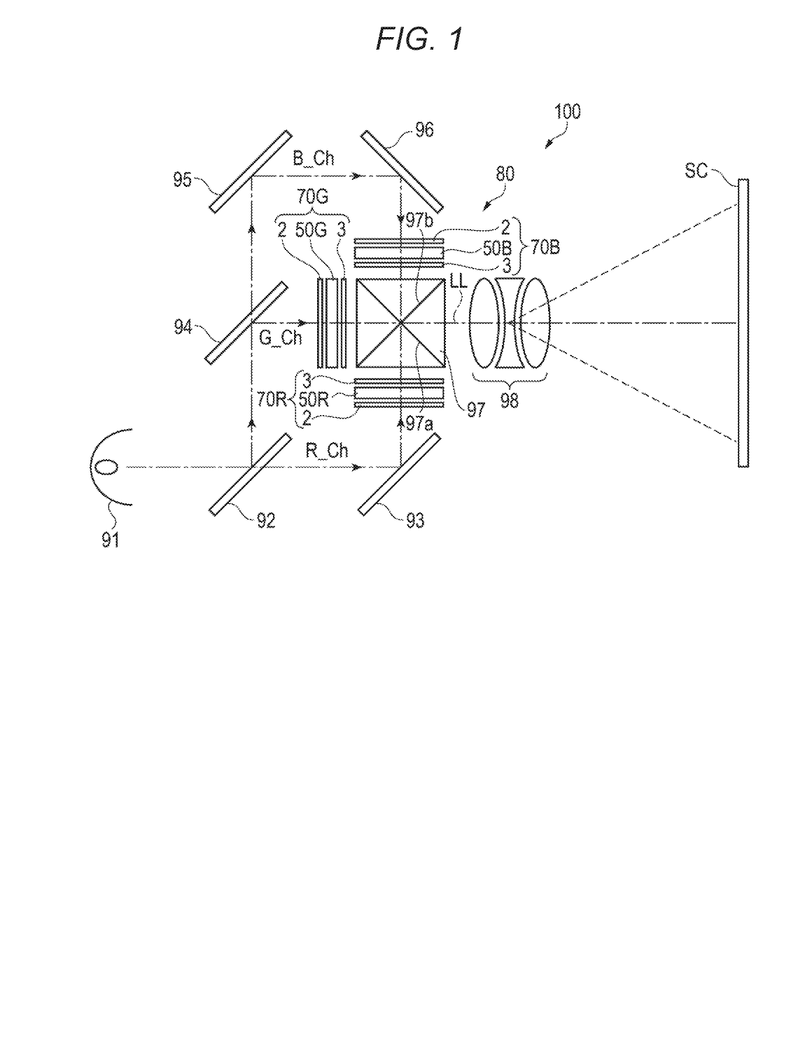

FIG. 1 is a schematic configuration diagram of a projection apparatus according to a first embodiment.

An embodiment of the present disclosure will be described below with reference to the drawings. The following embodiment describes an example of the present disclosure, and the present disclosure is not limited to the following embodiment, and includes various modifications implemented with no change in key points of the present disclosure. In the drawings below, dimensions and scales different from actual values are used in some cases for clarity of the description.

A projection apparatus 100 according to the present embodiment shown in FIG. 1 is a three-LCD projector using three liquid crystal panels as light modulators. The projection apparatus 100 enlarges a video based on an externally input video signal and projects the enlarged video on a screen SC.

The projection apparatus 100 includes a light source 91, a dichroic mirror 92, a mirror 93, a dichroic mirror 94, mirrors 95 and 96, electro-optical apparatuses 70R, 70G, and 70B, a dichroic prism 97, a projection lens 98, and the like, as shown in FIG. 1.

The light source 91 is a laser light source in a preferable example and outputs white light. Note that the light source 91 is not limited to a laser light source, and may be any light source that outputs white light, for example, a discharge-type light source such as a halogen lamp or a mercury lamp, or a solid-state light source such as a light emitting diode (LED). An optical integration system and a polarization conversion system may be provided between the light source 91 and the dichroic mirror 92. The optical integration system is configured, for example, with a pair of lens arrays and a superimposing lens, and the pair of lens arrays divide the light from the light source 91 into sub-luminous fluxes, which are collected by the superimposing lens on electro-optical panels. The polarization conversion system including polarization conversion elements arranged in an array is provided between the downstream lens array and the superimposing lens, and aligns the polarization directions of randomly polarized light with one another into linear polarized light. According to the configuration described above, the randomly polarized white light output from the light source 91 and having a nonuniform illuminance distribution is converted by the optical integration system and the polarization conversion system into linearly polarized white light polarized in a single direction and having a uniform illuminance distribution, which is incident on the dichroic mirror 92.

The white light output from the light source 91 is separated by the dichroic mirror 92 into red light (R) and other light.

The red light travels along an R channel that is a path along which the R light travels, is reflected off the mirror 93, and then enters the electro-optical apparatus 70R. The electro-optical apparatus 70R includes a light-incident-side polarizer 2, an electro-optical panel 50R, a light-exiting-side polarizer 3, and the like.

The other light is separated by the dichroic mirror 94 into green light (G) and blue light (B).

After reflected off the dichroic mirror 94, the green light travels along a G channel that is a path along which the G light travels, and enters the electro-optical apparatus 70G. The electro-optical apparatus 70G includes a light-incident-side polarizer 2, an electro-optical panel 50G, a light-exiting-side polarizer 3, and the like.

The blue light passes through the dichroic mirror 94, travels along a B channel that is a path along which the B light travels, is reflected off the mirrors 95 and 96, and then enters the electro-optical apparatus 70B. The electro-optical apparatus 70B includes a light-incident-side polarizer 2, an electro-optical panel 50B, a light-exiting-side polarizer 3, and the like.

The dichroic prism 97 is a cubic light combining system component, and the electro-optical apparatuses 70R, 70G, and 70B are disposed to face three surfaces of the dichroic prism 97. The dichroic prism 97 and the electro-optical apparatuses 70R, 70G, and 70B disposed at the three surfaces thereof are collectively referred to as an image generation module 80.

The dichroic prism 97 includes two built-in dichroic mirrors 97a and 97b, which intersect with each other, and the red light R and the blue light B incident from the two electro-optical apparatuses 70R and 70B facing each other are reflected off the dichroic mirrors 97a and 97b by 90 degrees, and the green light G incident from the electro-optical apparatus 70G passes through the dichroic mirrors 97a and 97b, as shown in FIG. 1. The red light R, the green light G, and the blue light B having entered the dichroic prism 97 are therefore combined with one another into display light LL used to display a color image, and the display light LL is output toward the projection lens 98.

The projection lens 98 is an enlarging optical system, enlarges the display light LL output from the dichroic prism 97, and projects the enlarged display light LL onto the screen SC.

Configuration of Image generation module

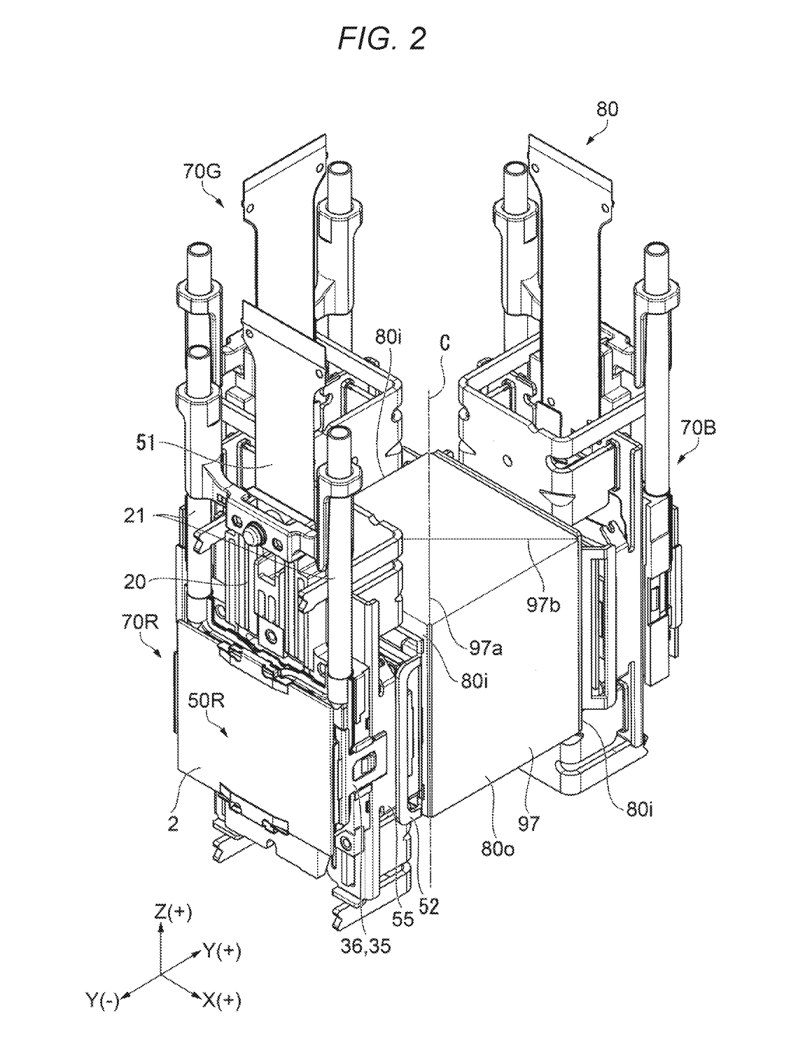

FIG. 2 is a perspective view of the image generation module.

The image generation module 80 includes the dichroic prism 97 and the electro-optical apparatuses 70R, 70G, and 70B disposed at the three surfaces of the dichroic prism 97, as shown in FIG. 2. An imaginary axis passing through the center of the portion where the two dichroic mirrors 97a and 97b of the dichroic prism 97 intersect with each other is hereinafter referred to as a center axis C.

The electro-optical apparatuses 70R, 70G, and 70B are provided to face the three surfaces out of four surfaces of the dichroic prism 97 that are surfaces parallel to the center axis C. The three surfaces of the dichroic prism 97 are light incident surfaces 80i.

The remaining one of the four surfaces of the dichroic prism 97 is a light exiting surface 80o, via which the combined image light is output. In the drawings including FIG. 2, it is assumed that the direction in which the center axis C extends is a Z direction, and that the direction perpendicular to the Z axis and extending from the light incident surface 80i for the electro-optical apparatus 70G toward the light exiting surface 80o is an X direction. It is further assumed that the direction perpendicular to the Z direction and the X direction is a Y direction.

A support member 52 is attached to the −Y-side light incident surface 80i of the dichroic prism 97. The electro-optical apparatus 70R is fixed to the −Y-side light incident surface 80i by causing a holding member 55 to engage with the support member 52. The holding member 55 is a frame body that houses the electro-optical panel 50R. The light-incident-side polarizer 2 is attached to the light incident side of the electro-optical apparatus 70R. A heat dissipater 20 is provided on the +Z side of the light-incident-side polarizer 2. The heat dissipater 20 is a heat sink and is integrated with the holding member 55. A portion of a flexible substrate 51 is exposed to a portion of the interior of the projection apparatus 100 that is the portion facing the +Z side of the heat dissipater 20. The flexible substrate 51 is coupled to the electro-optical panel 50R.

Two liquid flowing tubes 21 extend in the Z direction on opposite sides of the heat dissipater 20 in the X direction. The liquid flowing tubes 21 form a portion of a cooling unit in which a coolant that cools the electro-optical panel 50R circulates. Note that a cooling plate, a Peltier element, or any other cooling member can be disposed in place of or in addition to the liquid flowing tubes 21.

The configuration of the electro-optical apparatus 70G is the same as that of the electro-optical apparatus 70R except that the electro-optical panel 50G for G light is provided in place of the electro-optical panel 50R for R light. The configuration of the electro-optical apparatus 70B is also the same as that of the electro-optical apparatus 70R except that the electro-optical panel 50B for B light is provided in place of the electro-optical panel 50R for R light. The configuration of the electro-optical apparatus 70R will be representatively described below in detail.

Configuration of electro-optical apparatuses

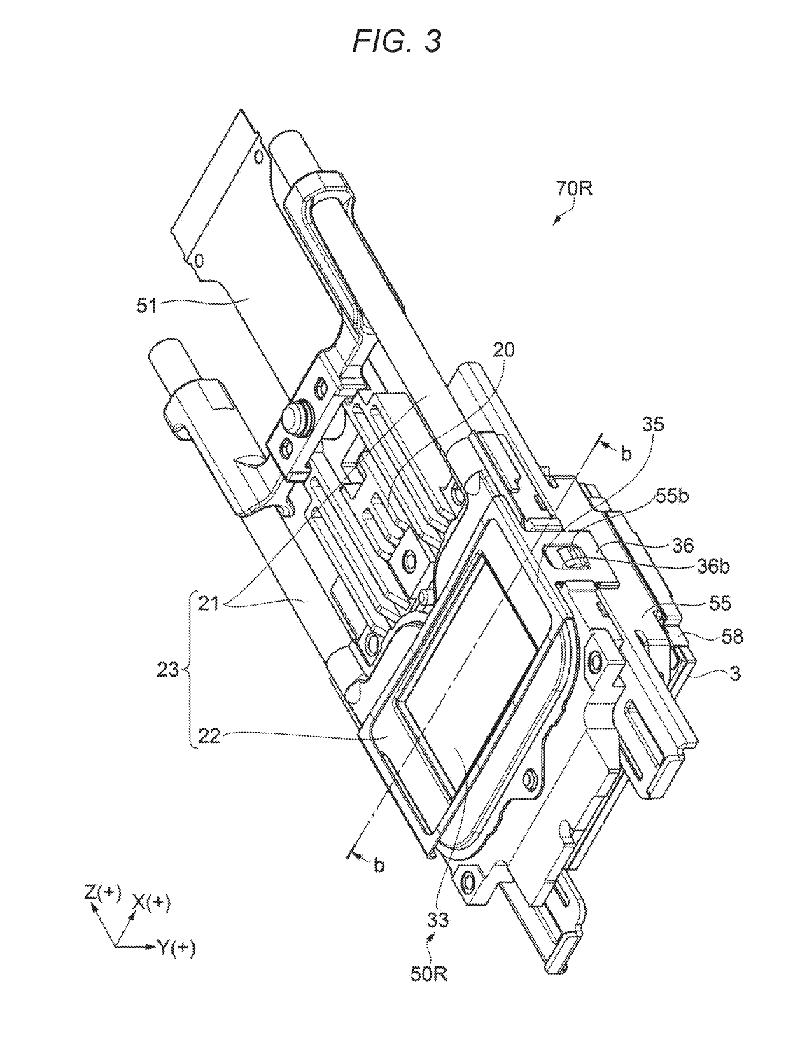

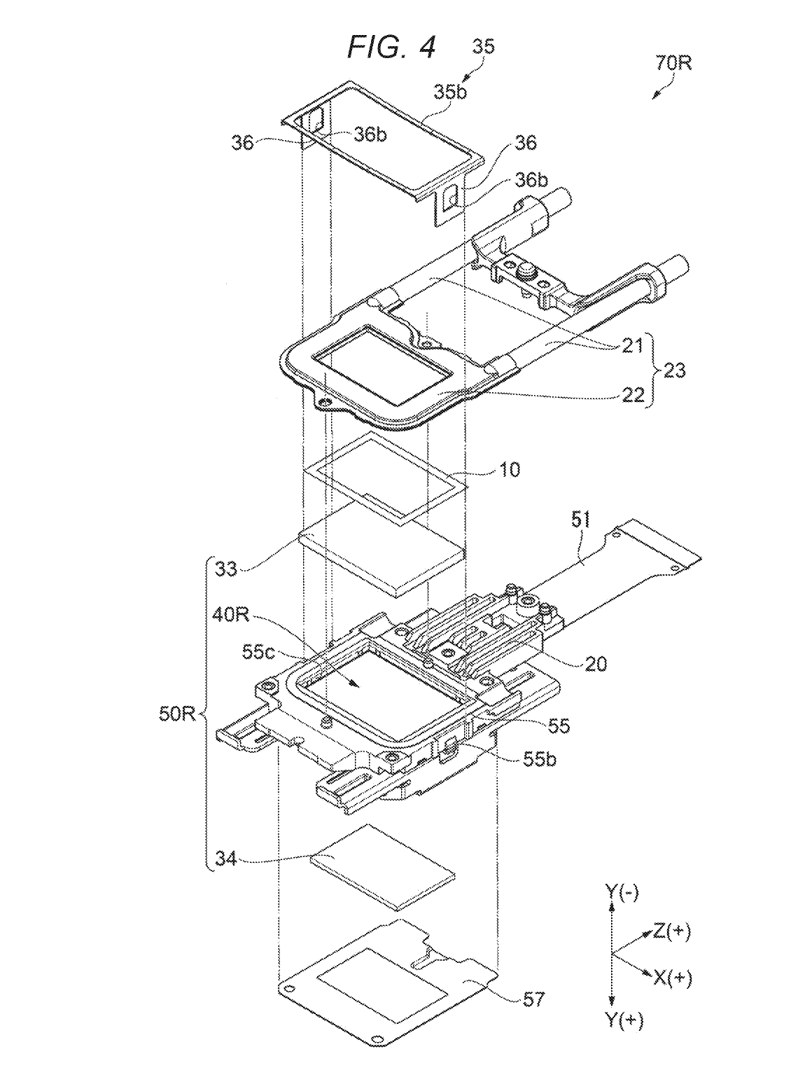

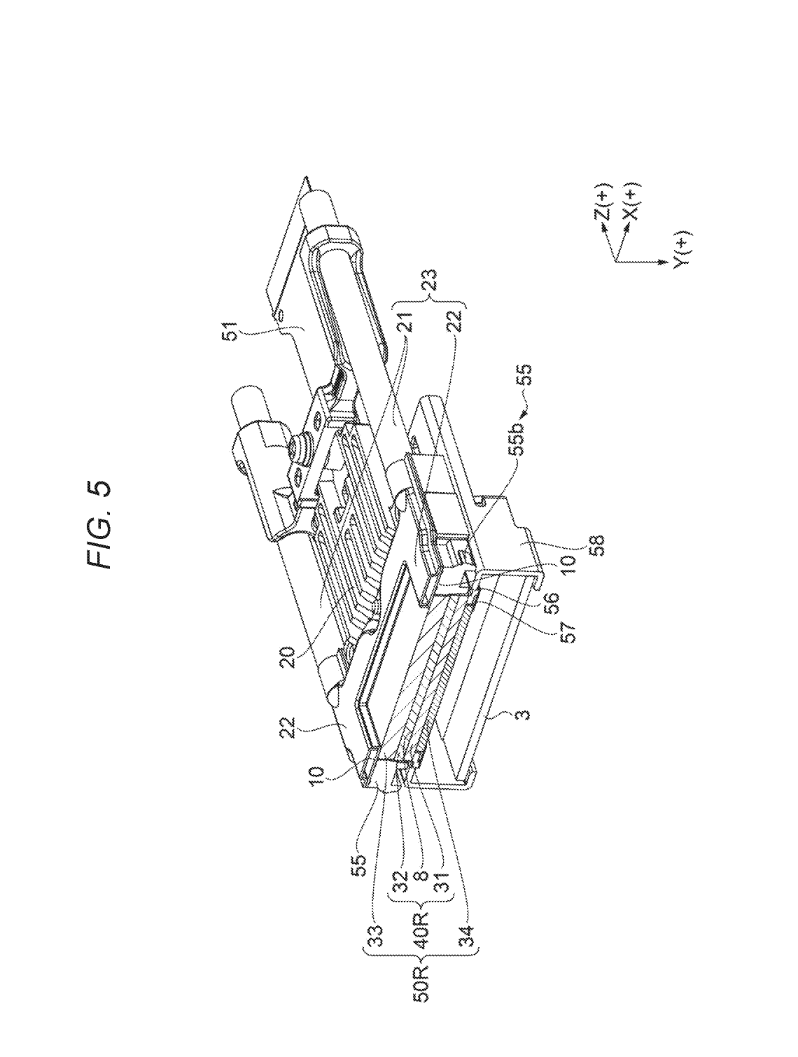

FIG. 3 is a perspective view of one of the electro-optical apparatuses. FIG. 4 is an exploded perspective view of the electro-optical apparatus. FIG. 5 is a perspective cross-sectional view of the electro-optical apparatus taken along the line b-b in FIG. 3. Note that FIGS. 3 to 5 do not show the light-incident-side polarizer.

The electro-optical apparatus 70R has a configuration primarily configured with the holding member 55, which houses the electro-optical panel 50R in which a light-incident-side portion is an assembly of a cooling unit 23 and the like and a light-exiting-side portion is an assembly of a second support plate 57 and the like, as shown in FIG. 4. Note that the light-incident-side portion of the electro-optical apparatus 70R is a −Y-side portion, and that the light-exiting-side portion is a +Y-side portion.

In a preferable example, the holding member 55 is a frame body produced by aluminum die casting into which a quadrangular housing 55c, which houses the electro-optical panel 50R, the heat dissipater 20, and the like are integrated. Note that the holding member 55 is not necessarily produced by aluminum casting, maybe made of any material having excellent thermal conductivity, and may, for example, be a component produced by metal cutting.

The electro-optical panel 50R is configured with a liquid crystal panel 40R, a light-incident-side dustproof substrate 33 as a third substrate, and a light-exiting-side dustproof substrate 34 as a fourth substrate, as shown in FIG. 5. The liquid crystal panel 40R is configured, for example, with an element substrate 31 as a first substrate, a counter substrate 32 as a second substrate, and a liquid crystal layer 8 interposed between the element substrate 31 and the counter substrate 32. In a preferable example, the liquid crystal layer 8 operates in a vertical alignment mode having negative permittivity anisotropy. In a preferable example, the liquid crystal panel 40R employs an active matrix driving method, and includes thin film transistors on a pixel basis. Note that the method for driving the liquid crystal panel 40R is not limited to the active matrix driving method, and may be any other driving method. In a preferable example, the element substrate 31 is a quartz substrate having a quadrangular shape. Note that the element substrate 31 is not limited to a quartz substrate, may be any transparent substrate, and may, for example, be a glass substrate. The same applies to the counter substrate 32.

One of the two long sides of the element substrate 31 that is the +Z-side side forms a protruding region (not shown) protruding from the counter substrate 32. Multiple coupling terminals are provided in the protruding region, to which the flexible substrate 51 is coupled. A video signal and a drive signal used to drive the liquid crystal panel 40R for display operation are supplied from the flexible substrate 51.

The light-incident-side dustproof substrate 33 is provided to overlap with the light incident surface of the counter substrate 32. In a preferable example, the light-incident-side dustproof substrate 33 is bonded to the counter substrate 32, but not necessarily. The light-incident-side dustproof substrate 33 is a plate-shaped member that suppresses adhesion of dust to the counter substrate 32, and is configured, for example, with a transparent member having excellent scratch resistance and heat resistance, such as sapphire.

The light-exiting-side dustproof substrate 34 is provided to overlap with the light exiting surface of the element substrate 31. In a preferable example, the light-exiting-side dustproof substrate 34 is bonded to the element substrate 31, but not necessarily. The light-exiting-side dustproof substrate 34 is a plate-shaped member that suppresses adhesion of dust to the element substrate 31, and is configured, for example, with a transparent member made of Neoceram or any other material.

In other words, the projection apparatus 100 includes the electro-optical panel 50R having the element substrate 31 as the first substrate, the counter substrate 32 as the second substrate, and the light-incident-side dustproof substrate 33 as the third substrate, which is bonded to the counter substrate 32 as one of the element substrate 31 and the counter substrate 32, and the holding member 55, which holds the electro-optical panel 50R.

Returning to FIG. 4, the description continues.

The cooling unit 23 is disposed on the light incident side of the holding member 55. The cooling unit 23 is configured with a quadrangular annular liquid flowing member 22 disposed to overlap with a circumferential edge portion of the light-incident-side dustproof substrate 33, two liquid flowing tubes 21 each having one end coupled to the liquid flowing member 22, and the like.

The other end of each of the two liquid flowing tubes 21 is coupled to a storage tank that is not shown. One of the liquid flowing tubes 21 supplies the liquid flowing member 22 with a coolant in the storage tank, and the other liquid flowing tube 21 causes the coolant having absorbed heat in the liquid flowing member 22 to return to the storage tank. The storage tank includes a cooling mechanism such as a heat sink, and is capable of cooling the coolant in the storage tank. The coolant is, for example, water or ethylene glycol.

A quadrangular ring-shaped thermally conductive member 10 is disposed between the light-incident-side dustproof substrate 33 and the liquid flowing member 22, as shown in FIG. 4. The thermally conductive member 10 will be described later in detail.

The liquid flowing member 22 engages with the holding member 55 with the liquid flowing member 22 pressed against the holding member 55 by a locking frame 35. The locking frame 35 is a member produced by pressing, for example, a stainless steel plate, and includes a quadrangular annular frame 35b and flanges 36 provided at the opposite short sides of the frame 35b. The flanges 36 are each a rectangular portion bent at an edge of the frame 35b in the +Y direction, and an engagement hole 36b is provided at the center of the flanges 36. Note that the material of the locking frame 35 is not limited to stainless steel, and may be any metal having rigidity and elasticity similar to those of stainless steel.

A pair of protrusions 55b are provided at side surfaces of the holding member 55 at positions corresponding to the flanges 36 of the locking frame 35, as shown in FIG. 4.

When the locking frame 35 is placed while pressing the liquid flowing member 22, the protrusions 55b of the holding member 55 are fitted into the engagement holes 36b of the flanges 36, as shown in FIG. 3. The cooling unit 23 is thus assembled to the light incident surface of the holding member 55.

The second support plate 57, which supports a circumferential edge portion of the light-exiting-side dustproof substrate 34, is provided on the light exiting side of the holding member 55, as shown in FIG. 4. The second support plate 57 is a member produced by pressing a metal material similar to that of the locking frame 35, and is fixed to the holding member 55.

A first support plate 56, which supports a circumferential edge portion of the liquid crystal panel 40R, is provided between the holding member 55 and the second support plate 57, as shown in FIG. 5. The first support plate 56 is a quadrangular annular member produced by pressing a metal material similar to that of the locking frame 35, and is fixed to the holding member 55. Note that FIG. 5 does not show the locking frame 35. A polarizer support frame 58 is provided on the light exiting side of the holding member 55. The polarizer support frame 58 is a frame body that supports the light-exiting-side polarizer 3, and is fixed to the holding member 55.

Arrangement of thermally conductive member

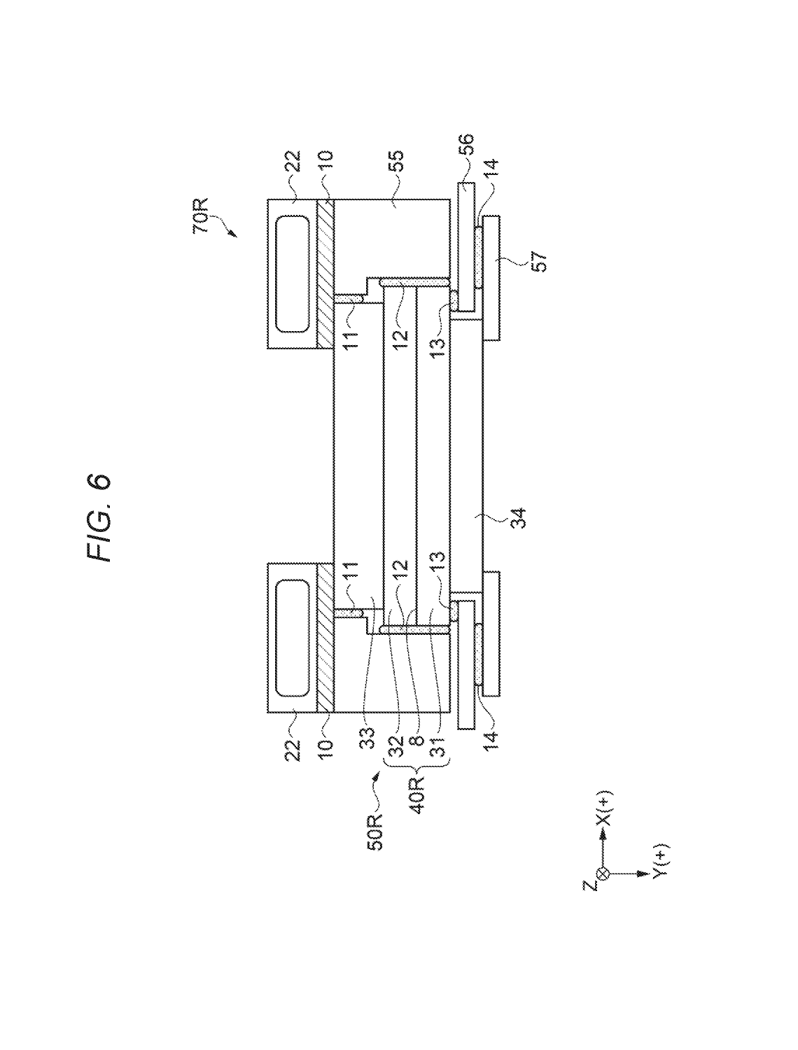

FIG. 6 is a diagrammatic cross-sectional view of key parts of the electro-optical apparatus taken along the line b-b in FIG. 3.

The liquid flowing member 22 is disposed to cover the circumferential edge portion of the light-incident-side dustproof substrate 33 and the holding member 55, as shown in FIG. 6. In other words, the liquid flowing member 22 is disposed to overlap with an end portion of the light-incident-side dustproof substrate 33 and the holding member 55 in the plan view.

The thermally conductive member 10 is sandwiched between the liquid flowing member 22 and the combination of the light-incident-side dustproof substrate 33 and the holding member 55. In other words, the thermally conductive member 10 is disposed between the light-incident-side dustproof substrate 33 and the liquid flowing member 22 and between the holding member 55 and the liquid flowing member 22.

The thermally conductive member 10 is a heat dissipating sheet, and is in a preferable example a carbon fiber sheet. The carbon fiber sheet is a heat dissipating sheet configured with a resin sheet in which carbon fillers are arranged in the thickness direction of the resin sheet, and has high thermal conductivity in the thickness direction of the sheet. Note that the thermally conductive member 10 is not limited to a carbon fiber sheet, and may be any heat dissipating sheet having heat dissipation performance comparable to that of a carbon fiber sheet.

As described above, since the thermally conductive member 10 is provided between the liquid flowing member 22 and the combination of the light-incident-side dustproof substrate 33 and the holding member 55, heat of the liquid crystal panel 40R and the holding member 55 can be efficiently transferred to the liquid flowing member 22, so that the electro-optical panel 50R can be efficiently cooled by the liquid-cooling-type cooling unit 23.

The end of the light-incident-side dustproof substrate 33 and the holding member 55 are bonded and fixed to each other by a first fixing member 11, as shown in FIG. 6. The first fixing member 11 is a thermally conductive adhesive, for example, a thermally conductive silicone adhesive. The thermally conductive silicone adhesive contains a filler having high thermal conductivity, such as carbon black or silver powder. Note that the first fixing member 11 may be a thermally conductive epoxy adhesive containing a filler having high thermal conductivity similar to that of the thermally conductive silicone adhesive. The first fixing member 11 is disposed at a side circumference portion of the light-incident-side dustproof substrate 33 that is a side circumference portion facing the thermally conductive member 10, and does not reach the counter substrate 32. Note that the thermal conductivity of the first fixing member 11 is higher than that of a typical adhesive but lower than that of the thermally conductive member 10.

In other words, the first fixing member 11 fixes the side surface of the light-incident-side dustproof substrate 33 to the holding member 55.

The side surface of the liquid crystal panel 40R and the holding member 55 are bonded and fixed to each other by a second fixing member 12. The second fixing member 12 is a thermally conductive adhesive similar to the first fixing member 11. The second fixing member 12 is disposed to be separate from the light-incident-side dustproof substrate 33 and the first fixing member 11, as shown in FIG. 6.

In other words, the electro-optical apparatus 70R includes the second fixing member 12, which fixes the side surfaces of the element substrate 31 and the counter substrate 32 to the holding member 55, and which is disposed to be separate from the first fixing member 11. The second fixing member 12 is further disposed separate from the light-incident-side dustproof substrate 33.

The element substrate 31 and the first support plate 56 are bonded and fixed to each other by a third fixing member 13, as shown in FIG. 6. The third fixing member 13 is a thermally conductive adhesive similar to the first fixing member 11. The third fixing member 13 is disposed separate from the second fixing member 12 and the light-exiting-side dustproof substrate 34. The first support plate 56, which is fixed to the holding member 55 as described above, can be regarded as a portion of the holding member 55.

In other words, the projection apparatus 100 includes the third fixing member 13, which fixes the element substrate 31 as the other substrate of the element substrate 31 and the counter substrate 32 to the first support plate 56 as a portion of the holding member 55, and which is disposed separate from the second fixing member 12. The electro-optical panel 50R includes the light-exiting-side dustproof substrate 34 as the fourth substrate, which is bonded to the element substrate 31 as the other substrate of the element substrate 31 and the counter substrate 32 and which is disposed separate from the third fixing member 13.

The first support plate 56 and the second support plate 57 are bonded and fixed to each other by a fourth fixing member 14, as shown in FIG. 6. The fourth fixing member 14 is a thermally conductive adhesive similar to the first fixing member 11. The fourth fixing member 14 is disposed separate from the light-exiting-side dustproof substrate 34. The second support plate 57, which is fixed to the holding member 55 as described above, can be regarded as a portion of the holding member 55.

As described above, since the thermally conductive first fixing member 11 is provided between the side surface of the light-incident-side dustproof substrate 33 and the holding member 55, and the thermally conductive second fixing member 12 is provided between the side surface of the liquid crystal panel 40R and the holding member 55, heat generated in the liquid crystal panel 40R can be efficiently transferred to the holding member 55. Since the heat of the holding member 55 is efficiently transferred to the liquid flowing member 22 via the thermally conductive member 10, the electro-optical panel 50R can be efficiently cooled by the liquid-cooling-type cooling unit 23.

Furthermore, the thermally conductive third fixing member 13 is provided between the element substrate 31 and the first support plate 56, and the thermally conductive fourth fixing member 14 is provided between the first support plate 56 and the second support plate 57, the heat generated in the liquid crystal panel 40R can be more efficiently transferred to the holding member 55.

When a fixing member is filled in the space between the side surface of the light-incident-side dustproof substrate 33 and the counter substrate 32, there is a concern that thermal contraction of the fixing member induces stress in the liquid crystal panel 40R, which affects the image quality, but good image quality can be ensured by separating the second fixing member 12 from the light-incident-side dustproof substrate 33.

Similarly, when a fixing member is filled in the space between the side surface of the light-exiting-side dustproof substrate 34 and the element substrate 31, there is a concern that thermal contraction of the fixing member induces stress in the liquid crystal panel 40R, which affects the image quality, but good image quality can be ensured by separating the third fixing member 13 from the light-exiting-side dustproof substrate 34.

As described above, the projection apparatus 100 according to the embodiment can provide the following advantages.

The projection apparatus 100 includes the electro-optical panel 50R including the element substrate 31 as the first substrate, the counter substrate 32 as the second substrate, and the light-incident-side dustproof substrate 33 as the third substrate bonded to the counter substrate 32 as one of the element substrate 31 and the counter substrate 32, the holding member 55, which holds the electro-optical panel 50R, the liquid flowing member 22 disposed to overlap with the end portion of the light-incident-side dustproof substrate 33 and the holding member 55 in the plan view, and the thermally conductive member 10 disposed between the light-incident-side dustproof substrate 33 and the liquid flowing member 22 and between the holding member 55 and the liquid flowing member 22.

The configuration described above, in which the thermally conductive member 10 is provided between the liquid flowing member 22 and the combination of the light-incident-side dustproof substrate 33 and the holding member 55, allows the heat of the liquid crystal panel 40R and the holding member 55 to be efficiently transferred to the liquid flowing member 22. Since the coolant circulates in the liquid flowing member 22, the heat of the electro-optical panel 50R can be efficiently dissipated out thereof by the liquid-cooling-type cooling unit 23.

The projection apparatus 100 can therefore be a projection apparatus having high cooling efficiency and good image quality.

The projection apparatus 100 further includes the first fixing member 11, which fixes the side surface of the light-incident-side dustproof substrate 33 to the holding member 55, and the second fixing member 12, which fixes the side surfaces of the element substrate 31 and the counter substrate 32 to the holding member 55 and which is disposed separate from the first fixing member 11.

The configuration described above, in which the highly thermally conductive first fixing member 11 is provided between the side surface of the light-incident-side dustproof substrate 33 and the holding member 55, and the highly thermally conductive second fixing member 12 is provided between the side surface of the liquid crystal panel 40R and the holding member 55, allows the heat generated in the liquid crystal panel 40R to be efficiently transferred to the holding member 55. Since the heat of the holding member 55 is efficiently transferred to the liquid flowing member 22 via the thermally conductive member 10, the electro-optical panel 50R can be efficiently cooled by the liquid-cooling-type cooling unit 23.

The second fixing member 12 is disposed separate from the light-incident-side dustproof substrate 33.

When a fixing member is filled in the space between the side surface of the light-incident-side dustproof substrate 33 and the counter substrate 32, there is a concern that thermal contraction of the fixing member induces stress in the liquid crystal panel 40R, which affects the image quality, but good image quality can be ensured by separating the second fixing member 12 from the light-incident-side dustproof substrate 33.

The projection apparatus 100 further includes the third fixing member 13, which fixes the element substrate 31 as the other substrate of the element substrate 31 and the counter substrate 32 to the first support plate 56 as a portion of the holding member 55 and which is disposed separate from the second fixing member 12.

The configuration described above, in which the highly thermally conductive third fixing member 13 is provided between the element substrate 31 and the first support plate 56, allows the heat generated in the liquid crystal panel 40R to be more efficiently transferred to the holding member 55.

The electro-optical panel 50R further includes the light-exiting-side dustproof substrate 34 as the fourth substrate, which is bonded to the element substrate 31 as the other substrate of the element substrate 31 and the counter substrate 32 and which is disposed separate from the third fixing member 13.

When a fixing member is filled in the space between the side surface of the light-exiting-side dustproof substrate 34 and the element substrate 31, there is a concern that thermal contraction of the fixing member induces stress in the liquid crystal panel 40R, which affects the image quality, but good image quality can be ensured by separating the third fixing member 13 from the light-exiting-side dustproof substrate 34.

What is claimed is:

1. A projection apparatus comprises:
an electro-optical panel including a first substrate, a second substrate, and a third substrate bonded to one of the first substrate and the second substrate;
a holding member configured to hold the electro-optical panel;
a liquid flowing member disposed to overlap with an end portion of the third substrate and the holding member in a plan view; and
a thermally conductive member disposed between the third substrate and the liquid flowing member and between the holding member and the liquid flowing member.

2. The projection apparatus according to claim 1, further comprising:
a first fixing member configured to fix a side surface of the third substrate to the holding member; and
a second fixing member configured to fix side surfaces of the first substrate and the second substrate to the holding member and disposed separate from the first fixing member.

3. The projection apparatus according to claim 2, wherein
the second fixing member is disposed separate from the third substrate.

4. The projection apparatus according to claim 2, further comprising
a third fixing member configured to fix another substrate of the first substrate and the second substrate to the holding member and disposed separate from the second fixing member.

5. The projection apparatus according to claim 4, wherein
the electro-optical panel includes a fourth substrate bonded to the other substrate of the first substrate and the second substrate and disposed separate from the third fixing member.
